(19) United States
(12) Patent Application Publication
(10) Pub. No.: US 2015/0172393 A1
(43) Pub. Date: Jun. 18, 2015

(54) Temporal Location Sharing

(71) Applicants: Andrew Oplinger, Mountain View, CA (US); Kenneth J. Leftin, San Francisco, CA (US); Kenneth Norton, San Carlos, CA (US); Joseph LaPenna, San Francisco, CA (US)

(72) Inventors: Andrew Oplinger, Mountain View, CA (US); Kenneth J. Leftin, San Francisco, CA (US); Kenneth Norton, San Carlos, CA (US); Joseph LaPenna, San Francisco, CA (US)

(73) Assignee: GOOGLE INC., Mountain View, CA (US)

(21) Appl. No.: 13/194,843

(22) Filed: Jul. 29, 2011

(51) Int. Cl. H04L 29/08

(52) U.S. Cl. CPC H04L 67/18; H04L 67/10

(57) ABSTRACT

The subject matter of this specification can be implemented in, among other things, a computer-implemented method for sharing location information among a group of participants, the method including generating an invitation to share location information between computing devices of multiple potential participants. The invitation specifies a period of time during which the location information is shared. The method further includes receiving a response to the invitation from each of one or more of the potential participants. Each response includes an identifier for a confirmed participant. The method further includes receiving location information from a computing device of each of the confirmed participants during the period of time. The method further includes providing an interface configured to display, for the period of time, a location of the computing device of each confirmed participant.

### TECHNICAL FIELD

This instant specification relates to sharing a location of a mobile computing device.

### BACKGROUND

Mobile devices such as mobile phones and smartphones are becoming more and more popular. Many mobile devices have the ability to provide location data, such as data from a global positioning system (GPS), cell towers in a cellular network, or Wi-Fi access points. The location data can then be used by the mobile device or another computing device to determine or estimate the location of the mobile device. Some mobile devices and systems also allow location data to be shared, such as by sharing a GPS track, a geo-tagged image, or by posting a place check-in to a social networking website.

### SUMMARY

In one aspect, a computer-implemented method for sharing location information among a group of participants includes generating an invitation to share location information between computing devices of multiple potential participants. The invitation specifies a period of time during which the location information is shared. The method further includes receiving a response to the invitation from each of one or more of the potential participants. Each response includes an identifier for a confirmed participant. The method further includes receiving location information from a computing device of each of the confirmed participants during the period of time. The method further includes providing an interface configured to display, for the period of time, a location of the computing device of each confirmed participant.

Implementations can include any, all, or none of the following features. The method can include providing a link to the invitation and presenting the invitation to one or more of the potential participants in response to requests from the one or more of the potential participants. The method can include receiving a request from one or more of the confirmed participants to display the locations of the confirmed participants and sending, in response to receiving the request to display the locations, a request to the computing device of each confirmed participant for the location of the computing device. Sending the request to the computing device for the location of the computing device can include sending a request for location information determined from a terrestrial-based system if none of the locations of the confirmed participants that sent the requests to display the locations are within a threshold distance of the computing device and sending a request for location information determined from a satellite-based system if one or more of the locations of the confirmed participants that sent the requests to display the locations are within the threshold distance of the computing device. The invitation can include a request to join a meeting event in a calendar system. The period of time for sharing the location information can be based on a time period of the meeting event. The request to join the meeting event can include a control for joining the meeting event and sharing a location, and a control for joining the meeting event without sharing a location.

In one aspect, a computer-implemented method for sharing location information among a group of participants includes receiving one or more user inputs that include information defining a location sharing event and which identify multiple potential participants for the location sharing event. The method further includes generating invitations to share location information between computing devices of the potential participants during the location sharing event. The method further includes presenting the invitations to one or more of the potential participants in response to requests from the potential participants. The method further includes receiving a response to the invitations from each of one or more of the potential participants. Each response includes an identifier for a confirmed participant. The method further includes receiving location information from a computing device of each of the confirmed participants. The method further includes providing an interface configured to display a location of the computing device of each confirmed participant.

Implementations can include any, all, or none of the following features. The method can include receiving a request from one or more of the confirmed participants to display the locations of the confirmed participants and sending, in response to receiving the request to display the locations, a request to the computing device of each confirmed participant for the location of the computing device. Sending the request to the computing device for the location of the computing device can include sending a request for location information determined from a terrestrial-based system if none of the locations of the confirmed participants that sent the requests to display the locations are within a threshold distance of the computing device and sending a request for location information determined from a satellite-based system if one or more of the locations of the confirmed participants that sent the requests to display the locations are within the threshold distance of the computing device. The invitation can include a request to join a meeting event in a calendar system. The period of time for sharing the location information can be based on a time period of the meeting event. The request to join the meeting event can include a control for joining the meeting event and sharing a location, and a control for joining the meeting event without sharing a location.

In one aspect, a computer-implemented system for sharing location information among a group of participants includes at least one interface configured to receive a request, from a client computing device, to generate an invitation to share location information between computing devices of multiple potential participants. The system further includes one or more processors configured to generate the invitation. The processors are further configured to provide the invitation to computing devices of the potential participants. The processors are further configured to receive a response to the invitation from each of a plurality of the potential participants. Each response includes an identifier for a confirmed participant. The processors are further configured to receive a request from one or more of the confirmed participants to display the locations of the confirmed participants. The processors are further configured to send, in response to receiving the request to display the locations, a request to the computing device of each of a first set of one or more of the confirmed participants for location information determined from a first location source if none of the locations of the confirmed participants that sent the requests to display the locations are within a threshold distance of the computing device from the first set. The processors are further configured to send, in response to receiving the request to display the locations, a request to the computing device of each of a second set of one or more of the confirmed participants for location information determined from a second location source if one or more of the locations of the confirmed participants that sent the requests to display the locations are within the threshold distance of the computing device from the second set. The processors are further configured to receive location information from a computing device of each of the confirmed participants. The processors are further configured to provide an interface configured to display a location of the computing device of each confirmed participant.

Implementations can include any, all, or none of the following features. The first location source can have a lower power usage than the second location source. The first location source can be a terrestrial-based location system and the second location source can be a satellite-based location system. Both the first location source and the second location source can be terrestrial-based location systems. The invitation can include a request to join a meeting event in a calendar system. The location information can be shared for a period of time that is based on a time period of the meeting event. The request to join the meeting event can include a control for joining the meeting event and sharing a location, and a control for joining the meeting event without sharing a location.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for temporarily sharing location information among multiple computing devices.

FIGS. 2A-D show examples of graphical user interfaces for generating an invitation to temporarily share location information among multiple computing devices.

FIGS. 3A-F show examples of graphical user interfaces for generating an invitation to temporarily share location information among multiple computing devices.

FIGS. 4A-D show examples of graphical user interfaces for managing temporarily shared location information among multiple computing devices.

FIGS. 5A-D show examples of graphical user interfaces for accepting an invitation to temporarily share location information among multiple computing devices.

FIG. 6 is flow chart that shows an example of a process for temporarily sharing location information among multiple computing devices.

FIG. 7 is a schematic diagram that shows an example of a computing device and a mobile computing device.

### DETAILED DESCRIPTION

This document describes systems and techniques for temporarily sharing location information among multiple computing devices. A computing system generates an invitation, to be sent from a first participant, to multiple other participants to share location information among the participants. One or more of the other participants respond to the invitation to confirm participation in the location information sharing event. The computing system then shares the location information of the confirmed participants for a limited amount of time. In some implementations, the computing system also throttles the type of location information requested from each of the confirmed participants based on the proximity of the confirmed participants to one another.

The systems and techniques described herein may provide one or more of the following advantages. First, a system can provide for sharing location information among multiple participants without separately authorizing the sharing between each pair of participants. Second, a system can provide for sharing location information among multiple participants without separate authorizations of the sharing in each direction between participants (e.g., first participant authorizes a second participant to see the first participant's location information and the second participant authorizes the first participant to see the second participant's location information). Third, a system can provide for temporarily sharing location information among multiple participants without participants separately revoking authorization of the sharing after the temporal time period has expired. Fourth, a system can provide a reduction in power consumed by a mobile computing device by only requesting location information that consumes a high amount of power when participants are within a threshold distance of one another.

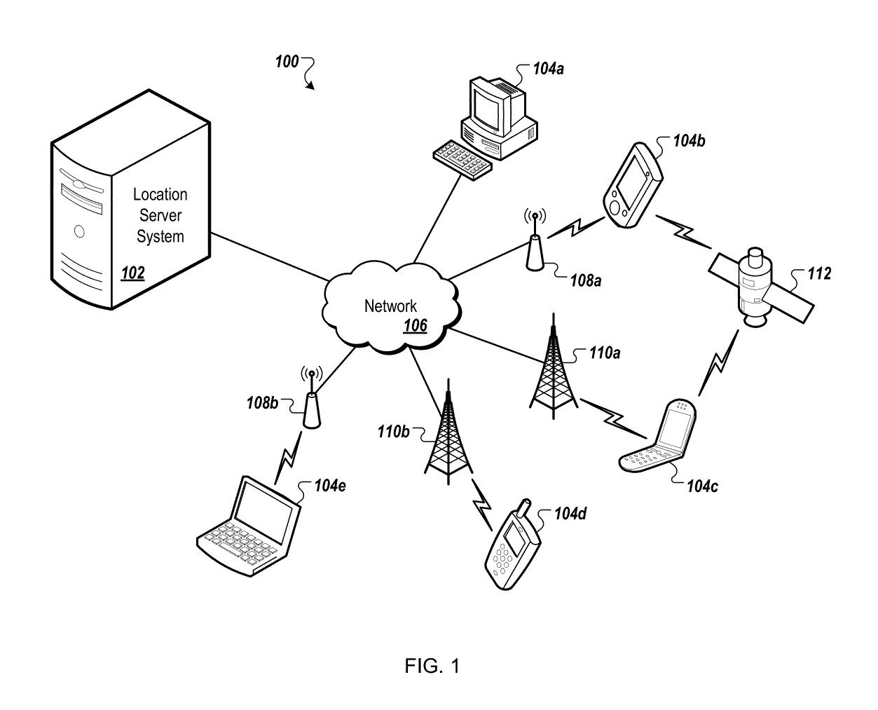

FIG. 1 is a schematic diagram that shows an example of a system 100 for temporarily sharing location information among multiple computing devices. The system 100 includes a location server system 102 in communication with multiple computing devices 104a-e through a network 106. The network 106 can include or be in communication with one or more other networks, such as one or more Wi-Fi networks 108a-b and one or more cellular telephone networks 110a-b. The computing devices 104a-e each provide location data to the location server system 102. The location data identifies or can be used to identify a location of each computing device. The location server system 102 then shares the location information among the computing devices 104a-e that have been identified as participants in a location sharing event.

The computing devices 104a-e can receive location data from one or more of multiple sources. For example, the computing device 104d can include an interface that receives location data from one or more cellular antenna towers in the cellular telephone network 110b, such as identifiers of the antennas and time difference of arrival for messages sent between the computing device 104d and the antennas. In another example, the computing device 104e can include an interface that receives location data from one or more Wi-Fi transmitters in the Wi-Fi network 108b, such as identifiers of the Wi-Fi transmitters and signal strength of the Wi-Fi transmitters as seen by the computing device 104e. In another example, the computing devices 104b-c can include interfaces that receive location data from one or more satellites in a global positioning system 112. In yet another example, the computing devices 104b-c can receive location data from multiple sources, such as the cellular telephone network 110a and the global positioning system 112, or the Wi-Fi network 108a and the global positioning system 112.

The computing devices 104a-e or another system, such as the location server system 102, then determine a location for the respective computing device using the location data. For example, the computing devices 104a-e or the location server system 102 can lookup an identifier of a cellular antenna or Wi-Fi transmitter in a database that correlates identifiers to locations. In another example, time difference of arrival data can be used to perform a multilateration operation to determine a location for a computing device. In another example, Wi-Fi signal strength can be used to refine a location of a computing device (e.g., the signal strength may be proportional to a distance between the computing device and the Wi-Fi transmitter, or a particular pattern of signal strengths may indicate a particular location).

A computing device, such as the computing device 104a, sends a request to the location server system 102 to generate an invitation for a location sharing event. The request can include information about the location sharing event, such as a time period for the event and recipients for the invitation.

In some implementations, the request from the computing device 104a to the location server system 102 can be a multi-step process between the computing device 104a and the location server system 102. For example, the location server system 102 can present a graphical user interface (GUI) that repeatedly prompts a user of the computing device 104a to input or select additional information regarding the location sharing event.

In some implementations, all or substantially all of the information needed to request generation of the invitation can be input or selected at the computing device 104a prior to the computing device 104a sending the initial request to the location server system 102. For example, after receiving the initial request, the location server system 102 can provide a GUI to the computing device 104a that allows the user of the computing device 104a to input or select optional information for generating the invitation.

Once the information for the location sharing event has been received, the location server system 102 generates the invitation and provides the invitation to the recipients identified in the request. For example, the request may include identifiers for email recipients, instant messaging (IM) recipients, or text message recipients. The identifiers can include actual addresses used for communication (e.g., email addresses, IM user names, or telephone numbers for text messages) or the identifiers included in the request can be used to lookup the actual addresses used for communication.

In some implementations, the location server system 102 generates the invitation and provides the invitation, or a link to the invitation, to the requester at the computing device 104a. The requester can then provide the invitation, or the link to the invitation, the recipients. For example, the requester at the computing device 104a can forward a Uniform Resource Locator (URL) to the recipients that directs the recipients to stored invitation information for the location sharing event at the location server system 102.

The invitation includes information describing the location sharing event. For example, the invitation can specify the time period during which the location information is shared, such as a particular range of dates and/or times of day, or a length of time measured from the current time or from another event. The invitation may indicate, to each recipient, the other recipients that have been invited to or that have accepted (e.g., in the case of the link to the location invitation stored at the location server system 102) the location sharing event. In some implementations, the invitation provides a recipient with an option to join the location sharing event and view location information during the location sharing event without providing location information.

One or more of the recipients provide responses to the location server system 102 that confirm participation in the location sharing event. During the time period for the location sharing event, the computing devices 104b-e of the confirmed participants provide location information to the location server system 102. The location server system 102 then provides locations of the computing devices 104b-e to participants that request the location information. In some implementations, the computing devices 104b-e provide location information to the location server system 102 in response to a request from the location server system 102 for the location information. For example, the location server system 102 can request location information from the computing devices 104b-e in response to a request from a participant to view the locations of the computing devices 104b-e that are participating in the event.

In some implementations, one or more the computing devices 104b-e can receive location data from multiple sources. For example, the computing device 104b can receive location data from the Wi-Fi network 108a and the global positioning system 112 and the computing device 104c can receive location data from the cellular telephone network 110a and the global positioning system 112. In some implementations, receiving location data from the global positioning system 112 consumes more power than receiving location data from either the cellular telephone network 110a or the Wi-Fi network 108a. Although, in some implementations, location data from the global positioning system 112 may have a higher accuracy and/or precision than location data the cellular telephone network 110a and/or the Wi-Fi network 108a. In some implementations, where multiple location data sources are available, the location server system 102 can request location data from a specific source.

For example, the location server system 102 can determine that each of the computing devices 104c-e is at least a minimum threshold distance from the computing device 104b. As a result, the location server system 102 specifies in the request for location information that a less accurate and/or precise type of location data source may be used, such as the Wi-Fi network 108a. In some implementations, the less accurate and/or precise type of location data source may be a terrestrial location system and the more accurate and/or precise type of location data source may be a satellite-based location system. In some implementations, the computing device 104b may chose a least accurate and/or precise type of location data source from among multiple terrestrial location systems, such as a Wi-Fi network and a cellular telephone network. In response to receiving the request for location information, the computing device 104b then retrieves the location data from the specified type of location data source (e.g., the Wi-Fi network 108a) and sends location information to the location server system 102.

Alternatively, the computing device 104b can use a more accurate and/or precise location data source, such as the global positioning system 112, if the computing device 104b determines that a condition for overriding the requested type of data source has been met. For example, a user of the computing device 104b can specify that the computing device 104b use a particular location data source regardless of the request from the location server system 102. In another example, the computing device 104b can determine that a power source (e.g., a vehicle power adapter or a mains power system) other than an internal power source, such as a battery, is currently being used. In response, the computing device 104b can override the request to use a specific type of location data source and use a most accurate and/or precise location data source that is currently available, such as the global positioning system 112.

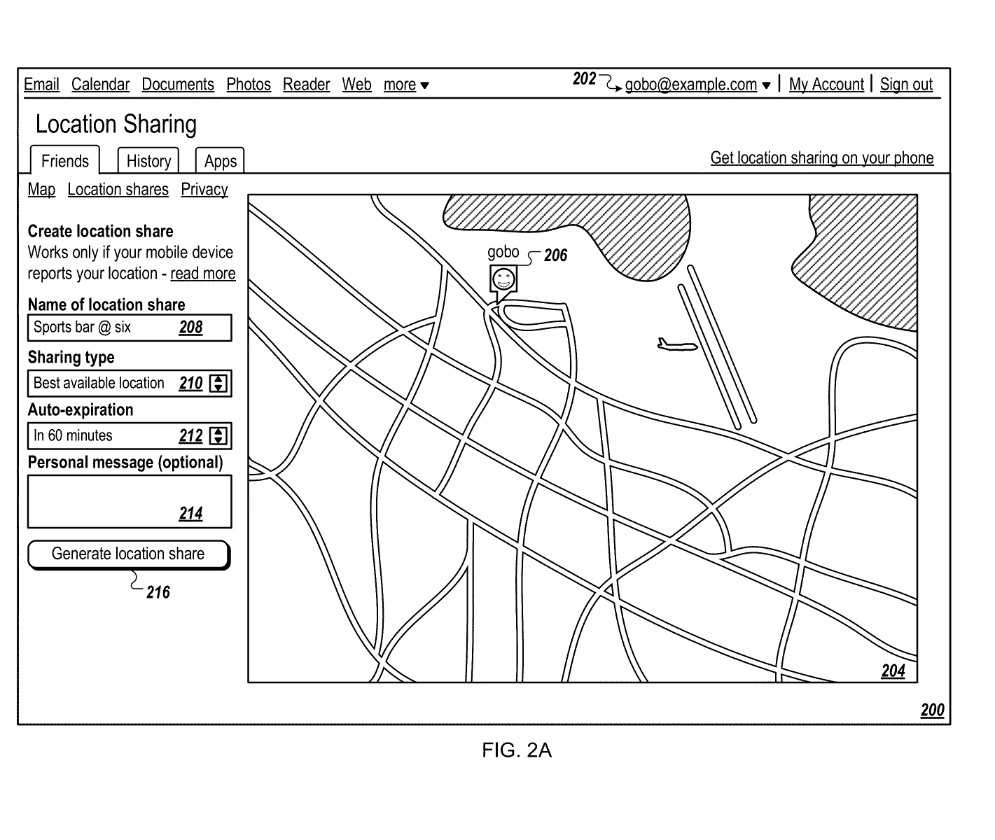

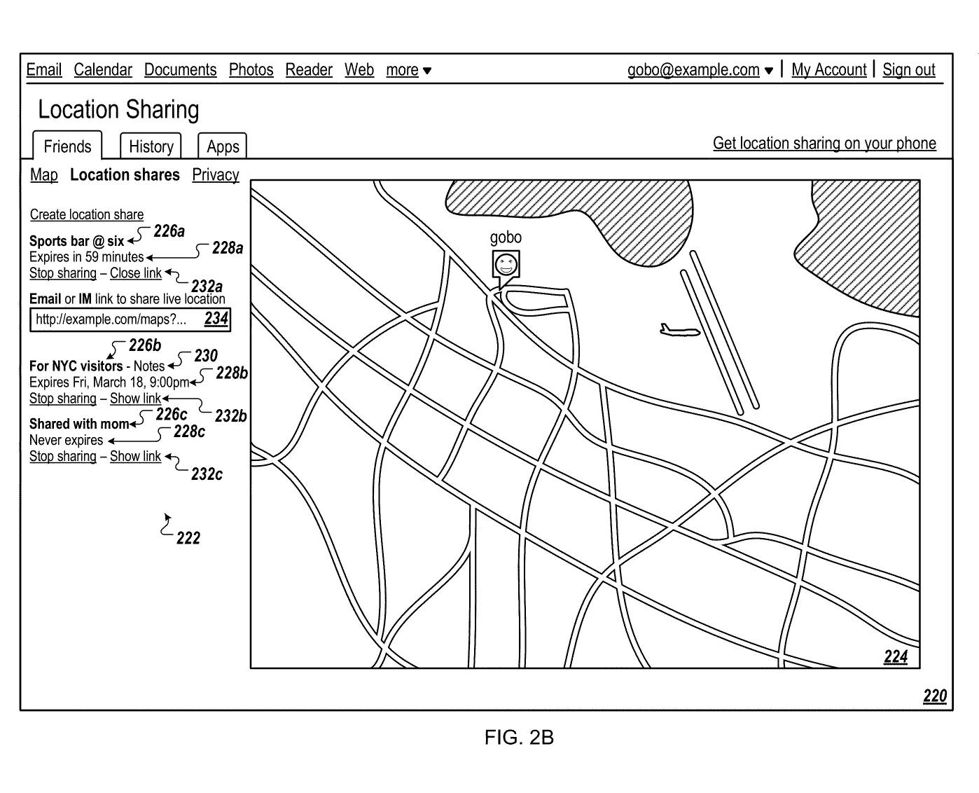

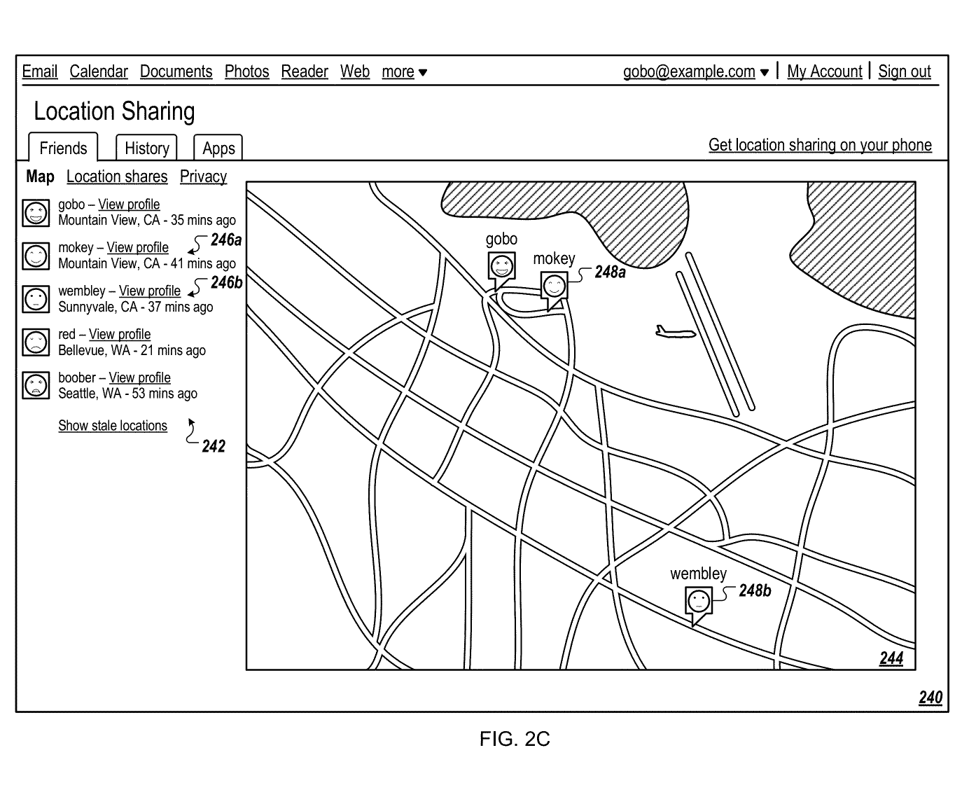

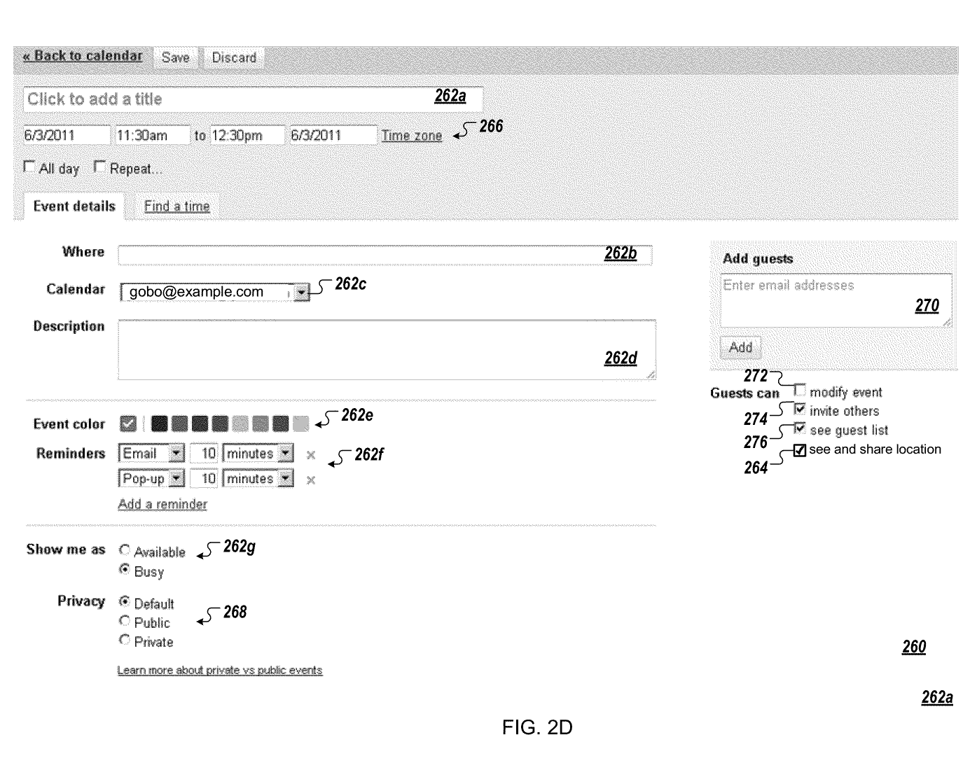

FIG. 2A shows an example of a graphical user interface (GUI) 200 for generating an invitation to temporarily share location information among multiple computing devices. In some implementations, the GUI 200 is a web page that can be provided by a system, such as the location server system 102, to a web browser application at a desktop computing device, such as the computing device 104a. The GUI 200 includes an indication 202 that a user named gobo is currently accessing the location sharing system. The GUI 200 also includes a map 204 that shows a location 206 of the user gobo and locations of other users that share location information with the user gobo.

The GUI 200 includes user input controls in which the user can input parameters for creating an invitation for a location sharing event. In particular, the GUI 200 includes a name field 208 in which the user can input a name, such as “Sports bar @ six,” for a location sharing event where the user intends to meet some friends at a sports bar in the near future. The GUI 200 includes a type field 210 with which the user can select a sharing type for the location sharing event. Sharing types can include, for example, a best available location (e.g., always use a global positioning system if available), a neighborhood-level location (e.g., “Mission District, San Francisco”), a city-level location (e.g., “Sausalito”), a country-level location (e.g., “France”), and a place-level location (e.g., “The Local Coffee Shop”).

The GUI 200 includes an auto-expiration field 212 in which the user can input or select a time period for the location sharing event. In some implementations, the user can select from a list of time periods, such as a particular number of minutes, hours, or days from the current time. In some implementations, the user can specify a particular date and time range, such as July fourth, 2011, from one pm to three pm, or July fourth, 2011, at noon until July sixth, 2011, at two pm. For example, the GUI 200 can include a calendar control (not shown) that presents a graphical representation of a calendar in which the user can select dates and/or times for the auto-expiration field 212.

The GUI 200 includes a message field 214 in which the user can input a personal message or note to be presented to the recipients of the location sharing event. When the user has finished inputting the parameters for the location sharing event, the user can select a control 216 to send the request to generate the location invitation to the location server system 102.

FIG. 2B shows an example of a GUI 220 for presenting a list 222 of location sharing events. The GUI 220 also includes a map 224 that shows the location of the current user as well as other users that are sharing location information with the current user.

The items in the list 222 each include a title 226a-c for the respective location event, such as “Sports bar @ six,” “For NYC visitors,” and “Shared with mom.” Each of the items in the list 222 also includes an indication 228a-c of the duration for the respective location sharing event, such as “Expires in 59 minutes,” “Expires on Friday, March 18, 9:00 pm,” and “Never expires.” In some implementations, if the location sharing event is not yet active (e.g., a start date and/or time has yet been reached), then the item can indicate when the location event will start, such as “Starts in 59 minutes” or “Starts on Thursday, March 18 at 6:00 am.” If the location sharing event has an associated note, such as a message entered in the message field 214, then the GUI 220 also presents a note control 230. A user can select the note control 230 to request that the message for the location sharing event be presented in the GUI 220.

Lastly, each of the items in the list 222 includes one or more controls 232a-c for stopping the sharing of location data and for showing and/or closing a link to the location sharing event. For example, a user can select the “stop sharing” portion of the control 232c to stop sharing location information with participants in the “shared with mom” event. In some implementations, selecting the control to stop sharing also stops the sharing of location information for the other participants of the event as well. In some implementations, only a request from the initiator of the location sharing event can stop or postpone location for all participants of the location sharing event.

A user can select the “show link” portion for either of the controls 232b-c to send a request for the GUI 220 to present a link for inviting other participants to the location sharing event. The “Sports bar @ six” event currently displays a link 234 for inviting other participants as well as a “close link” portion of the control 232a for closing the link 234. In some implementations, the GUI 220 automatically presents the link 234 in response to the user selecting the control 216 to generate the “Sports bar @ six” event.

The user can copy an address from the link 234 and use another application, such as an email application or an instant messaging application, to send the address to other participants for the event. The address can be, for example, a Uniform Resource Locator (URL) or Uniform Resource Identifier (URI) that includes domain and/or path information for the location sharing system and/or the event. In addition to domain and path information, the address can include parameters, such as an identifier for the event and/or the user initiating the event. In some implementations, the parameters can be encrypted.

One or more recipients of the address can then accept the invitation by selecting the address. In some implementations, a user interface presented in response to selecting the address may prompt the potential participant for additional information, such as login information and/or sharing preferences. In some implementations, a user interface presented in response to selecting the address may show information related to the invitation, such as other participants that have accepted the invitation, and times and dates for the location sharing event.

FIG. 2C shows an example of a GUI 240 for presenting a list 242 of location sharing participants. The GUI 240 also includes a map 244 that shows the location of the current user as well as users that are participating in location sharing events with the current user. For example, a first item 246a in the list 242 includes information about the associated user, such as a name or nickname of the user (e.g., mokey), a general location (e.g., Mountain View, Calif.), an indication of how recently the location for the user was updated (e.g., thirty-five minutes ago), and a picture or avatar for the user. The map 244 includes location markers that correspond to items from the list 242 that are currently within the area shown in the map 244. For example, the first item 246a has a marker 248a on the map 244 and a second item 246b has a marker 248b on the map 244. The markers can also include information about the associated user, such as a picture or avatar, and a name or nickname.

FIG. 2D shows an example of a GUI 260 for creating a calendar and location sharing event. The GUI 260 includes multiple fields 262a-g for configuring parameters of the event, such as a title, a place for the event, a calendar with which the event is associated, a description, a color for displaying the event, reminders for the event, and an availability status. The GUI 260 also includes one or more fields for configuring location sharing for the event.

For example, the GUI 260 can include a location sharing control 264. A user can toggle the location sharing control 264 to a checked or active state to enable location sharing for the event. In some implementations, enabling location sharing by a meeting organizer alone does not automatically enable location sharing from all participants. For example, a recipient of the calendar invitation can be presented with a user interface that has separate controls for accepting the invitation with and without sharing location information. In addition, the user interface for the calendar invitation recipient can also present information for the invitation, such as identities of the participants, identities of the invitees, and the times and dates for the sharing of location information. In some implementations, a recipient can specify a default response to location sharing requests, such as automatically accepting location sharing requests, automatically accepting requests from a particular user address or identifier (e.g., gobo@example.com), and/or automatically accepting requests from a particular domain of addresses or identifiers (e.g., example.com).

The GUI 260 includes a date and time control 266 for specifying a date and time or a range of dates and times for the calendar event. This date and time information can also be used by the location server system 102 to determine the times during which location information is shared between the participants. For example, the location server system 102 can share location information between the participants for the duration of the meeting. The location server system 102 can also share the location information for a particular amount of time before and/or after the appointment. In some implementations, the GUI 260 or another GUI (e.g., a GUI that allows configuration of default settings for the user or the calendar) includes controls for specifying the amount of time before and/or after an appointment to share location information.

The GUI 260 includes a privacy control 268 that allows a user to choose between a default privacy setting for the user and/or calendar, and public or private settings. In some implementations, the choices for the default privacy setting are also public and private. In some implementations, a private event indicates that the calendar information is only shared with the participants of the event. The shared calendar information can include, for example, location information for the participants of the event. The location server system 102 can authenticate users prior to sharing location information when an event is set to the private setting. In some implementations, a public event indicates that location information can be shared with users who are not participants in the event. For example, the event organizer, or another participant, can provide an address (e.g., similar to the address from the link 234) of the event to another user.

The GUI 260 also includes a participants control 270. A user can input addresses or identifiers for event participants into the participants control 270. Upon generating the event and, in some implementations, upon updating the event, the location server system 102 sends the generated event invitation to the potential participants listed in the participants control 270. As previously described, the invitation and/or a user interface accessible from the invitation (e.g., a web page or application window resulting from selecting a link in the invitation) can include one or more controls that allow the recipient to accept the invitation with or without sharing location information.

The GUI 260 further includes multiple permissions controls that allow the initiator of the event, or in some cases another user, to specify permissions for the event participants. For example, a modify permissions control 272 specifies whether or not the participants can modify parameters for the event. In addition, an invitation permissions control 274 specifies whether or not the participants can invite additional participants. Finally, a list permissions control 276 specifies whether the participants can see the list of participants for the event. In some implementations, the list permissions control 276 also determines whether participants can see the locations of the other participants as apposed to only the meeting organizer seeing the locations of the participants and/or each participant only seeing the location of the meeting organizer.

While the preceding GUIs have shown user interfaces typically suited to a desktop type of computing device, the location server system 102 and/or client computing devices can also provide user interfaces for other types of computing devices. For example, the system 100 can include user interfaces for mobile computing devices (e.g., a smartphone) and/or touch screen computing devices (e.g., a touch screen smartphone or a tablet computing device).

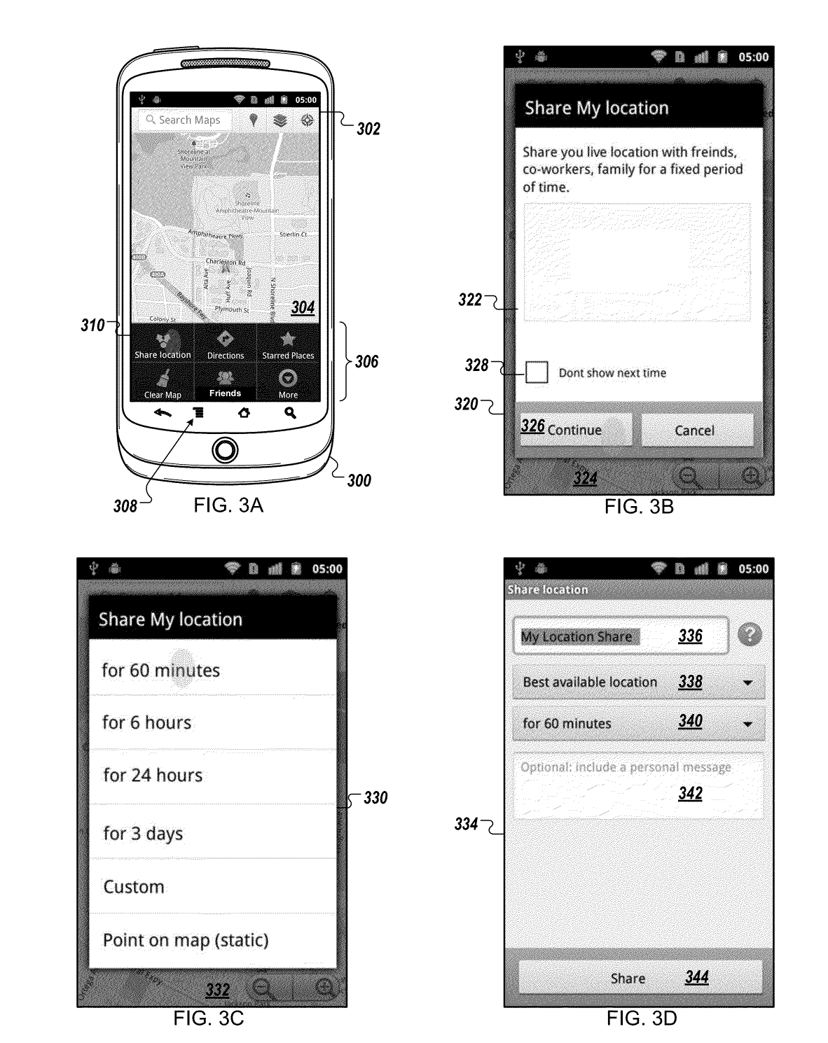

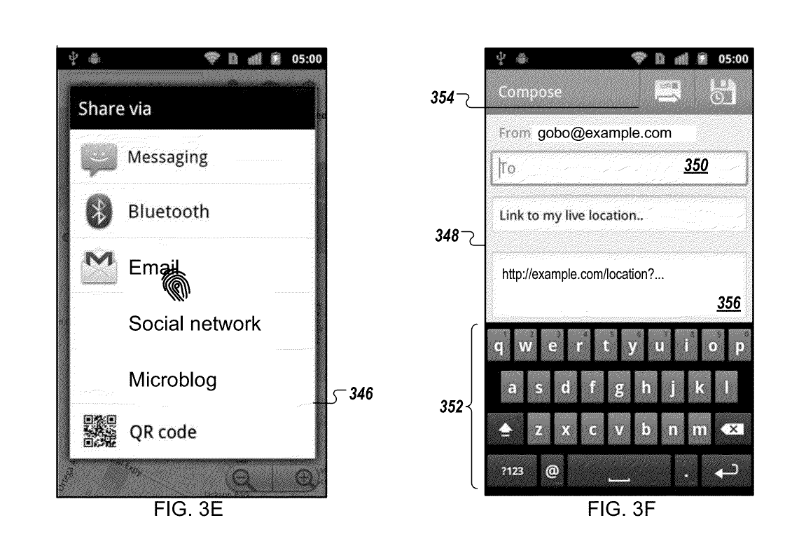

FIG. 3A shows an example of a mobile computing device 300 and a GUI 302 for generating an invitation to temporarily share location information among multiple computing devices. In some implementations, the interface includes a touch screen with which a user can make inputs to the GUI 302. In some implementations, the mobile computing device 300 also includes other interfaces, such as one or more dedicated touch screen controls and one or more hardware buttons for interacting with the GUI 302.

The GUI 302 currently presents an interface for a map application. In some implementations, the interface for the map application is a web application provided over a network by a server, such as the location server system 102. In some implementations, the map application is a local application installed at the mobile computing device 300. The GUI 302 for the map application includes a map area 304 that shows a map for a particular geographic location. The GUI 302 is currently displaying a menu 306. A user can request that the GUI 302 display the menu 306, for example, by selecting a menu button 308. The menu 306 includes a share location control 310. A user can select the share location control 310 to begin a series of interfaces for inputting parameters of a location sharing event.

FIG. 3B shows an example of a GUI 322 that informs the user that the user is about to share location information. The GUI 322 can be overlaid, for example, on a map area 324. The GUI 322 includes a continue control 326 that, when selected by the user, causes the mobile computing device 300 to proceed with the generation of the location sharing event. The GUI 322 also includes a control 328 to prevent the map application from displaying the warning regarding the sharing of location information for subsequent generation of location sharing events.

FIG. 3C shows an example of a GUI 330 that prompts the user to select or input a time period for the location sharing event. Again, the GUI 330 can be presented as an overlay on a map area 332 of the map application. The GUI 330 includes options for sharing location information for an ensuing amount of time, such as the next sixty minutes, six hours, twenty-four hours, and three days. The GUI 330 also includes an option for inputting a custom time period. For example, the user can select the custom time period option to open a GUI for selecting a specific starting date and time for the location sharing event as well as an ending date and time. In addition, the GUI 330 includes an option for sharing location information for a particular point on map. For example, whenever the user's computing device is determined to be within a particular distance from the point on the map, then the location server system 102 shares the location information with the event participants.

FIG. 3D shows an example of a GUI 334 that presents an alternate way in which a user can input parameters for a location sharing event. The GUI 334 includes a title input control 336 in which a user can input a title for the location sharing event. For example, upon selecting the title input control 336, the GUI 334 can present an onscreen soft keyboard (not shown).

The GUI 334 also includes a sharing type control 338 that allows the user to select the type of location information to be shared. For example, the user can select a best available location, which will request the most accurate location information available from the devices of the participants. In another example, the user can select another location type that is less specific than the best available location (e.g., neighborhood, city, country, or place), which will allow less specific location data, such as a location derived from cellular tower and/or Wi-Fi network locations.

The GUI 334 includes a time period control 340. Similarly to the GUI 330, the time period control 340 allows the user to select or input a time period during which the location server system 102 receives and shares location information among the participants. The GUI 334 includes an input control 342 that allows the user to input an optional message that can be displayed to potential participants that view the location sharing invitation. Finally, the GUI 334 includes a control 344 that the user can select to complete the parameter input process and to proceed with creation of the invitation.

FIG. 3E shows an example of a GUI 346 that presents options for methods of sharing the location sharing invitation. The GUI 346 can be presented in response to, for example, the GUI 330 and/or the GUI 334. The methods of sharing include links to applications provided by the mobile computing device 300 for sending information to another computing device. In some implementations, the GUI 346 can be dynamically updated based on the particular applications that are installed at the mobile computing device 300. The methods of sharing can include, for example, a text message or instant message, a Bluetooth transfer, an email, a social network posting or message, a microblog posting, and/or a Quick Response (QR) code. In the example, shown here the user has selected the email option, as indicated by the finger print.

FIG. 3F shows an example of a GUI 348 for emailing a link to an invitation for a location sharing event to one or more potential participants. In some implementations, the GUI 348 is provided by an email application that is separate from the map application. For example, the map application can pass information for a link 356 to the event and a subject line for the email message to the email application. The GUI 348 includes an address input control 350 in which the user can input one or more email addresses of the potential participants using a touch screen keyboard 352. The user can select a submit control 354 to send the invitation to the potential participants. A recipient can then select the select the link 356 to accept the invitation and/or view information for the invitation, such identities of the accepted participants, and the times and dates for the location sharing event.

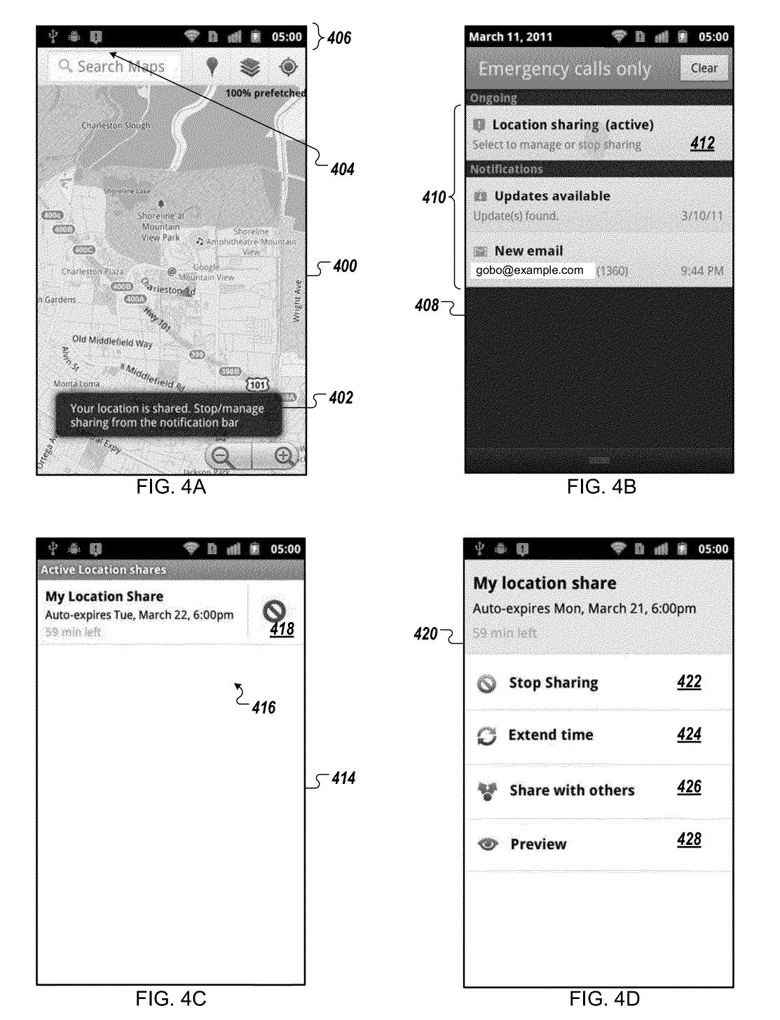

FIG. 4A shows an example of a GUI 400 for a map application. The GUI 400 includes a message 402 that indicates the map application is currently sharing location information. The GUI 400 also includes a notification 404 in a notification bar 406. The notification 404 also indicates that the map application is currently sharing location information. The notification 404 continues to be displayed in the notification bar 406 even when the mobile device switches to another application. A user can open the notification bar 406, for example by dragging the notification bar 406 downward, to see more detailed information for the notification 404.

FIG. 4B shows an example of a GUI 408 that presents an expanded notification bar 410. The expanded notification bar 410 includes an item 412 that indicates location sharing is currently active. A user can select the item 412 to open a user interface for managing location sharing events.

FIG. 4C shows an example of a GUI 414 for managing location sharing. The GUI 414 presents a list 416 of one or more active location sharing events. Each active location sharing event includes a title, an indication of when the location sharing event expires, and a stop control 418. A user can select the stop control 418 to instruct the map application to stop sharing location information for the selected event. In some implementations, selecting the stop control 418 stops sharing of location information for all participants of the sharing event. A user can select a location sharing event from the list 416 to see more detailed information for the event and to manage the event.

FIG. 4D shows an example of a GUI 420 for managing a location sharing event. The GUI 420 includes information about the location event, such as a title and an indication of when the active location sharing event expires. The GUI 420 also includes a stop control 422, which a user can select to stop sharing location information for the event. The GUI 420 presents a time control 424, which a user can select to modify the time period during which the location information is shared for the event. For example, the user can extend or reduce the end time, or input a specific end date and time. The GUI 420 allows the user to add more participants using a share control 426. For example, selecting the share control 426 may can initiate the GUI 346 described above. The GUI 420 also presents a preview control 428. For example, a user can select the preview control 428 to see a representation of what the participant will see, such as a preview of an invitation and/or a map of participant locations from the perspective of the participant.

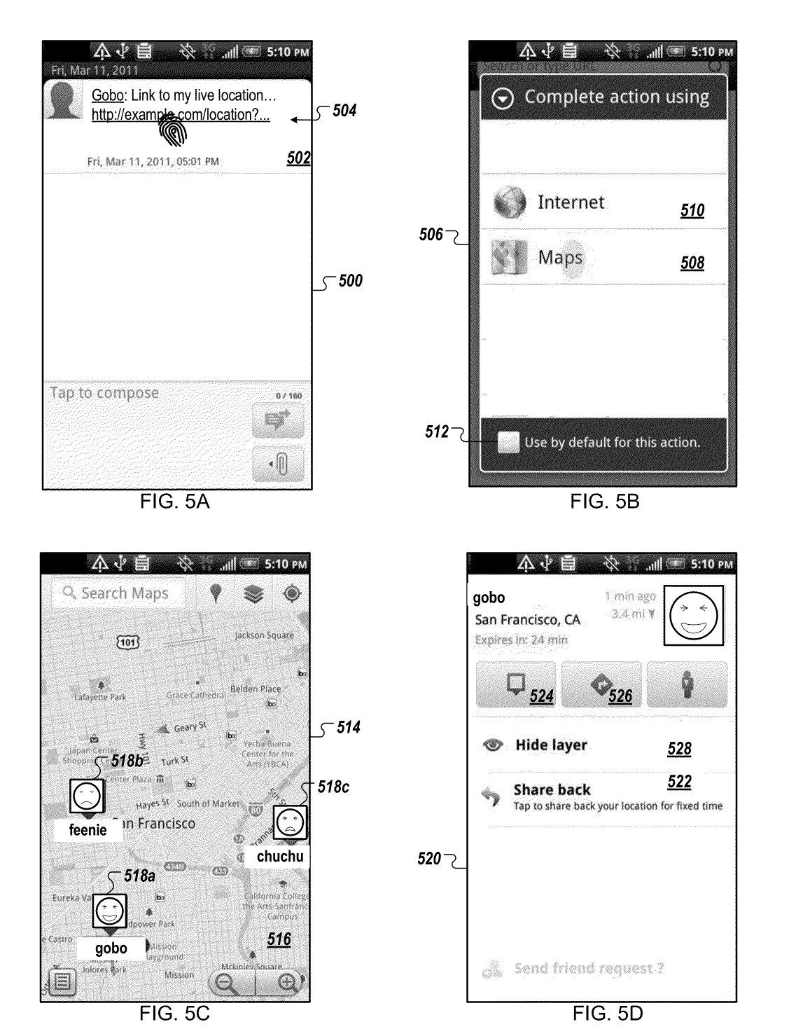

FIG. 5A shows an example of a GUI 500 for receiving an invitation for a location sharing event. In this example, the GUI 500 is provided by a text messaging or instant messaging application. Other applications can be used for receiving a location sharing invitation, such as an email application or the applications shown in the GUI 346. The GUI 500 presents a message 502 for the location sharing invitation from the user gobo. The user can select a link 504 in the message to accept the invitation.

FIG. 5B shows an example of a GUI 506 for selecting an application to process the link 504. The GUI 506 includes a list of controls for applications that can process the link 504, such as a map application control 508 and a browser application control 510. In some implementations, the location server system 102 can provide a web application that is accessible by a browser application at a client computing device and/or a map application at a client computing device can communicate with the location server system 102. In the example shown here, the user selects the map application control 508. The user can also select a default control 512 to specify that future selections of the link 504 automatically use the map application as apposed to, for example, the browser application.

FIG. 5C shows an example of a GUI 514 for presenting shared location information. The GUI 514 can be provided by, for example, a map application. The map application receives location information for participants in a location sharing event and presents the location information in a map area 516. The map application uses the location information from each participant to present multiple icons 518a-c for the participants in the map area 516. A user can select an icon, such as the icon 518a, to display additional information for the participant.

FIG. 5D shows an example of a GUI 520 for presenting additional information about a participant in a location sharing event. The GUI 520 presents a name or nickname for the participant, a city and/or region in which the participant is located, and an indication of when the location sharing event will expire. A user can select a share back control 522 to share location information back to the event initiator and/or other participants. The GUI 520 also includes a map control 524 for showing the icon for the participant in the map area 516. A user can select a directions control 526 to request directions to the location of the participant from the location of the current user. The user can also hide the location information for the participant by selecting a hide control 528.

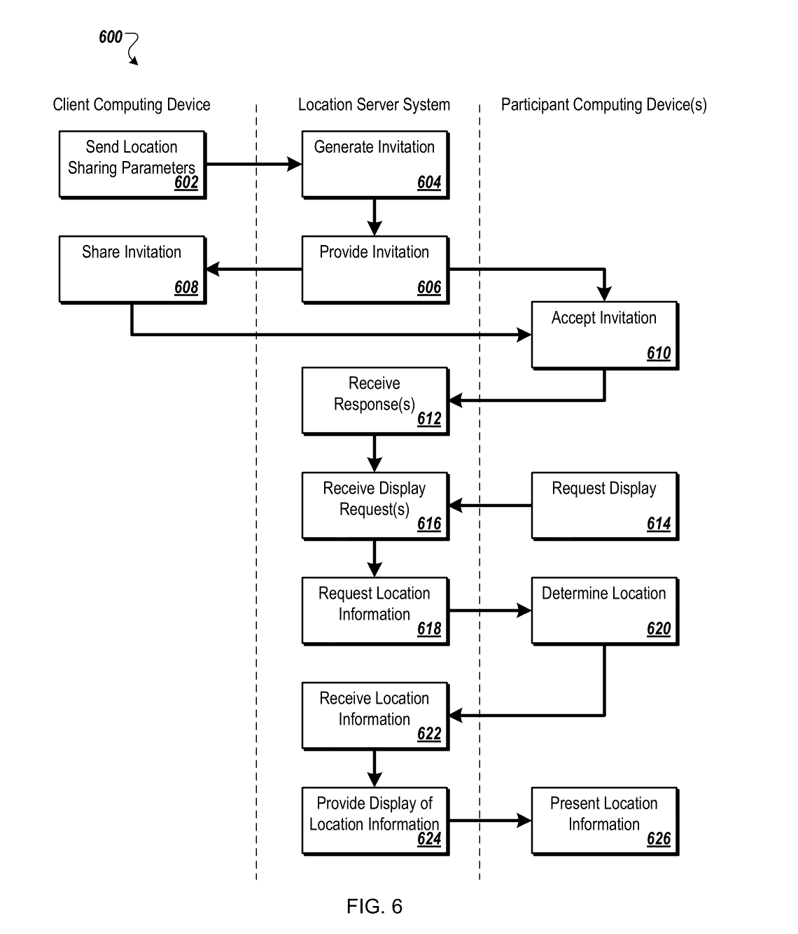

FIG. 6 is flow chart that shows an example of a process 600 for temporarily sharing location information among multiple computing devices. The process 600 may be performed, for example, by a system such as the system 100. For clarity of presentation, the description that follows uses the system 100 as an example for describing the process 600. However, another system, or combination of systems, may be used to perform the process 600. The process 600 begins with a computing device sending (602) location sharing parameters to a location server system.

The location server system receives the parameters and generates (604) an invitation to share location information between computing devices of multiple potential participants. The invitation specifies a limited time for which the location information is shared.

The location server system provides (606) the invitation for sending to computing devices of the potential participants. For example, the location server system 102 can provide the link 234 in the GUI 220 and/or the link in the GUI 348 to the computing device that requested generation of the event. The requesting computing device can then send (608) the invitation to potential participants. In another example, the location server system 102 can send the invitation to the potential participants.

The location server system receives (610) a response to the invitation from each of one or more of the potential participants. Each response includes an identifier for a confirmed participant. For example, a map application at a computing device of the participant can access the location sharing event using a link in the invitation. The map application can then provide information regarding the participant, such as an identifier and/or authentication information that identifies the participant. One or more of the participants then accept (612) the invitation for the location sharing event.

A computing device sends (614) a request to display location information for the event. For example, the computing device can be associated with the original event requestor and/or another participant.

The location server system receives (616) the requests from the confirmed participants to display the locations of the confirmed participants. In response, the location server system sends (618) a request to the computing device of each confirmed participant for the location of the computing device.

Each participant computing device determines (620) a location for the respective computing device and sends the location information to the location server system. The location server system receives (622) location information from each of the confirmed participants during the limited time and in response to the request from the location server system for the location information.

The location server system provides (624) an interface configured to display, for the limited time, a location of a computing device of each confirmed participant. The computing device receives the interface information and presents (626) the interface on a display device. For example, the location server system 102 can provide location information for presentation by a standalone map application at a client computing device. In another example, the location server system 102 can provide the location information in a web page or information for display in a web page by a web application at the client computing device.

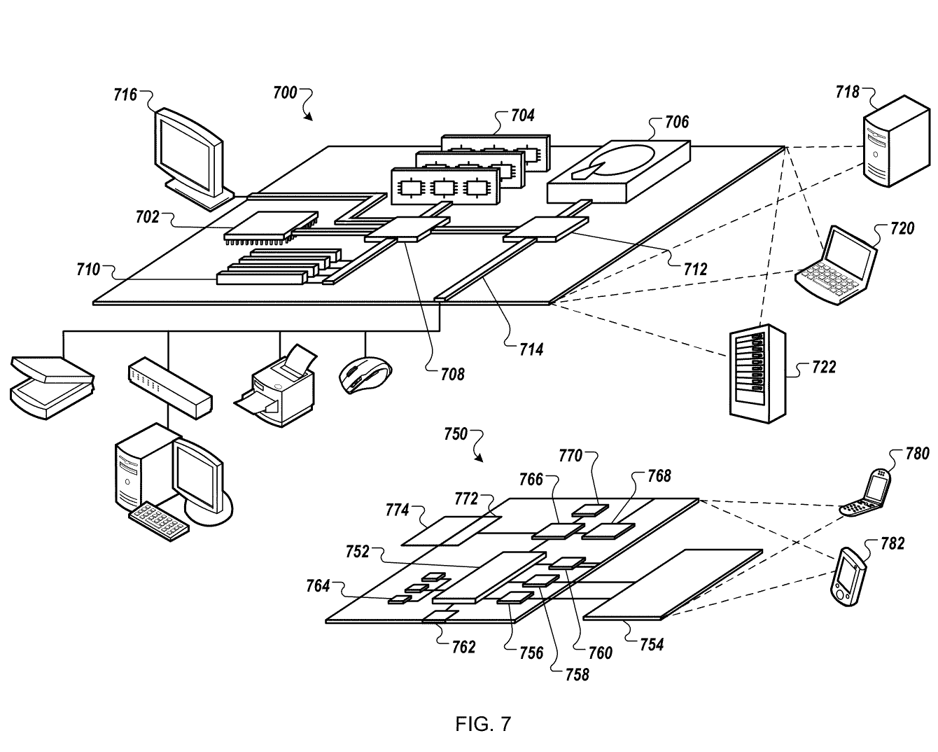

FIG. 7 is a schematic diagram that shows an example of a computing device 700 and an example of a mobile computing device that can be used to implement the systems and techniques described here. The computing device 700 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations.

A computer program product can be tangibly embodied in an information carrier. The computer program product may contain instructions that, when executed, perform one or more methods, such as those described above. The computer program product can also be tangibly embodied in a computer- or machine-readable medium, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is exemplary only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 718, or multiple times in a group of such servers. In addition, it may be implemented in a personal computer such as a laptop computer 720. It may also be implemented as part of a rack server system 722. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. The memory 764 may include, for example, flash memory and/or NVRAM memory (non-volatile random access memory).

An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a secure manner.

In some implementations, a computer program product is tangibly embodied in an information carrier. The computer program product contains instructions that, when executed, perform one or more methods, such as those described above. The computer program product can be a computer- or machine-readable medium, such as the memory 764, the expansion memory 774, or memory on the processor 752. In some implementations, the computer program product can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth, Wi-Fi, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems discussed here use personal information about users, the users may be provided with an opportunity to opt in/out of programs or features that use personal information (e.g., information about a user's preferences or a user's current location or previous location). In addition, certain data may be made anonymous in one or more ways before it is stored or used, so that personally identifiable information is removed. For example, a user's identity may be made anonymous so that the no personally identifiable information can be determined for the user, or a user's geographic location may be generalized where location information is obtained (such as to a city, zip code, or state level), so that a particular location of a user cannot be determined.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A computer-implemented method for sharing location information among a group of participants, the method comprising:
generating an invitation to share location information between computing devices of multiple potential participants, wherein the invitation specifies a period of time during which the location information is shared;
presenting the invitation to one or more of the potential participants;
receiving a response to the invitation from each of one or more of the potential participants, wherein each response includes an identifier for a confirmed participant;
receiving location information from a computing device of each of the confirmed participants during the period of time;
providing an interface configured to display, for the period of time, a location of the computing device of each confirmed participant; and
specifying permission control for one or more confirmed participants, the permission control including one or more of: whether event participants are permitted to view the list of participants for the event, or whether event participants are permitted to view the locations of other participants.

2. The method of claim 1, further comprising:
providing a link to the invitation; and
presenting the link to the invitation to one or more of the potential participants in response to requests from the one or more of the potential participants.

3. The method of claim 1, further comprising:
receiving a request from one or more of the confirmed participants to display the locations of the confirmed participants; and
sending, in response to receiving the request to display the locations, a request to the computing device of each confirmed participant for the location of the computing device.

4. The method of claim 3, wherein sending the request to the computing device for the location of the computing device comprises:
sending a request for location information determined from a terrestrial-based system if none of the locations of the confirmed participants that sent the requests to display the locations are within a threshold distance of the computing device; and
sending a request for location information determined from a satellite-based system if one or more of the locations of the confirmed participants that sent the requests to display the locations are within the threshold distance of the computing device.

5. The method of claim 3, wherein the invitation comprises a request to join a meeting event in a calendar system.

6. The method of claim 5, wherein the period of time for sharing the location information is based on a time period of the meeting event.

7. The method of claim 6, wherein the request to join the meeting event includes a control for joining the meeting event and sharing a location, and a control for joining the meeting event without sharing a location.

8. A computer-implemented method for sharing location information among a group of participants, the method comprising:
receiving one or more user inputs that include information defining a location sharing event and which identify multiple potential participants for the location sharing event;
generating invitations to share location information between computing devices of the potential participants during the location sharing event;
presenting the invitations to one or more of the potential participants in response to requests from the potential participants;
receiving a response to the invitations from each of one or more of the potential participants; wherein each response includes an identifier thr a confirmed participant;
receiving location information from a computing device of each of the confirmed participants;
providing an interface configured to display a location of the computing device of each confirmed participant; and
specifying permission control for one or more confirmed participants, the permission control including one or more of: whether event participants are permitted to view the list of participants for the event, or whether event participants are permitted to view the locations of other participants.

9. The method of claim 8, further comprising;
receiving a request from one or more of the confirmed participants to display the locations of the confirmed participants; and
sending, in response to receiving the request to display the locations, a request to the computing device of each confirmed participant for the location of the computing device.

10. The method of claim 9, wherein sending the request to the computing device for the location of the computing device comprises;
sending a request for location information determined from a terrestrial-based system if none of the locations of the confirmed participants that sent the requests to display the locations are within a threshold distance of the computing device; and
sending a request for location information determined from a satellite-based system if one or more of the locations of the confirmed participants that sent the requests to display the locations are within the threshold distance of the computing device.

11. The method of claim 10, wherein the invitation comprises a request to join a meeting event in a calendar system.

12. The method of claim 11, wherein the period of time for sharing the location information is based on a time period of the meeting event.

13. The method of claim 12, wherein the request to join the meeting event includes a control for joining the meeting event and sharing a location, and a control for joining the meeting event without sharing a location.

14. A computer-implemented system for sharing location information among a group of participants, the system comprising:
at least one hardware interface configured to receive a request, from a client computing device, to generate an invitation to share location information between computing devices of multiple potential participants; and
one or more processors configured to:
generate the invitation;
provide the invitation to computing devices of the potential participants;
receive a response to the invitation from each of a plurality of the potential participants, wherein each response includes an identifier for a confirmed participant;
receive a request from one or more of the confirmed participants to display the locations of the confirmed participants;
send, in response to receiving the request to display the locations, a request to the computing device of each of a first set of one or more of the confirmed participants for location information determined from a first location source if none of the locations of the confirmed participants that sent the requests to display the locations are within a threshold distance of the computing device from the first set;
send, in response to receiving the request to display the locations, a request to the computing device of each of a second set of one or more of the confirmed participants for location information determined from a second location source if one or more of the locations of the confirmed participants that sent the requests to display the locations are within the threshold distance of the computing device from the second set;
receive location information from a computing device of each of the confirmed participants;
provide an interface configured to display a location of the computing device of each confirmed participant; and
specify permission control for one or more confirmed participants, the permission control including one or more of: whether event participants are permitted to view the list of participants for the event, or whether event participants are permitted to view the locations of other participants.

15. The system of claim 14, wherein the first location source has a lower power usage than the second location source.

16. The system of claim 15, wherein the first location source is a terrestrial-based location system and the second location source is a satellite-based location system.

17. The system of claim 15, wherein both the first location source and the second location source are terrestrial-based location systems.

18. The system of claim 15, wherein the invitation comprises a request to join a meeting event in a calendar system.

19. The system of claim 18, wherein the location information is shared for a period of time that is based on a time period of the meeting event.

20. The system of claim 19, wherein the request to join the meeting event includes a control for joining the meeting event and sharing a location, and a control for joining the meeting event without sharing a location.
